(19) United States
(12) Patent Application Publication
(10) Pub. No.: US 2003/0174717 A1
(43) Pub. Date: Sep. 18, 2003

(54) System and method for longest prefix match for internet protocol lookup

(76) Inventors: Boris Zabarski, Tel Aviv (IL); Vadim Pasternak, Lod (IL)

Correspondence Address: Kevin T. Duncan, Esq., Hunton & Williams, Intellectual Property Department, 1900 K Street, N.W., Suite 1200, Washington, DC, 20006, US

(21) Appl. No.: 10/097,598

(22) Filed: Mar. 15, 2002

(51) Int. Cl. H04L 12/56; H04J 3/16

(52) U.S. Cl. 370/401; 370/466

(57) ABSTRACT

A system and method for performing longest prefix matching processing, such as that employed for IP destination address lookups, is disclosed. The technique, referred as the Optimized Multi-bit Trie (OMT) approach, maps a routing table having prefix entries and next hop identification (NHID) values into a compact and readily searchable data structure. LPM searches of the OMT data structure can be performed without backtracking and without loops on the trie level. LPM searches of the OMT data structure can be performed without performing condition checks. The OMT data structure is constructed for a routing table so that the LPM searches are performed according to a fixed number of levels. The OMT technique reduces the number of memory accesses required for identifying LPM matches and is fast and memory efficient.

### FIELD OF THE INVENTION

The present invention relates generally to network routing, and more particularly, to a technique for performing network destination lookups based on search values.

### BACKGROUND OF THE INVENTION

Communication between computer systems on networks, such as communications on the Internet, may involve a number of cooperating components, such as the user computers (e.g., the client and the server), hubs (which link groups of computers together), bridges (which link Local Area Networks [LANs] together), gateways (similar to bridges, but which also translate data from one kind of network to another), repeaters (which amplify the signal at certain intervals to offset signal loss), and routers.

In a so-called packet-switched network, routers are used to direct traffic within networks and between networks. In packet-switched networks, application data may be disassembled into a series of packets, each with a source IP address, and each with a destination IP address. The series of packets are separately transmitted from the source to the destination such that it is possible that the packets will take different paths and/or arrive at different times. At the destination end, the packets are reassembled into the application data by examining control data that indicates their correct sequence.

Therefore, in a packet-switched network, routers will receive packets into their input ports and make a routing determination before forwarding the packets out of their output ports. The routing determination is made by examining the packet to determine its destination IP address and, based on certain factors such as network volume, assigning a next stop destination (“next hop”) that takes the packet to the next available router that is closest to the packet's destination address.

In Transport Control Protocol/Internet Protocol (TCP/IP) networks, such as the Internet, the data is placed in an “IP envelope” or “IP datagram” that includes the source IP address and the destination IP address. In today's IPv4 Internet environment, IP addresses are 32 bit addresses which can be expressed as four numbers separated by dots, such as 163.52.128.72. Thus, a router receiving a packet with the destination address 163.52.128.72 will examine this address based on a routing table that is used to convert the destination address to a “next hop address” (usually corresponding to another router).

IP addressing has a two level hierarchy. Generally, IPv4 32 bit addresses are made up of a network address (more significant bits that specify which network the host is on) and a host address (less significant bits that identify the specific host on the network). Typically, routing tables have one routing entry per network address. Generally, the network address portion of an IP address is referred to as the IP prefix.

Routers may be static or dynamic, meaning that their routing tables may be statically determined or dynamically determined based on a routing protocol. Dynamic routers consider traffic on the network and the number of hops (i.e., the number of routers on a best path computed by a router). Dynamic routers allow for the routing table to be updated based on changes in traffic or changes in network topology.

There are several routing protocols that may be used, such as those for routing internal to a network and those for routing between networks. Internal routing, such as for routing inside a company Intranet, uses interior gateway protocols like the Routing Information Protocol (RIP) (defined in RFC 1058) or the Open Path Shortest First (OPSF) protocol (defined in RFC 1247). External routing, such as for routing on the Internet, uses exterior gateway protocols like the Exterior Gateway Protocol (EGP) or Border Gateway Protocol (BGP).

The routing protocol can be considered a process that, based on various information inputs and the protocol's metric (e.g., the metric may be shortest distance or number of hops), periodically computes the best path to any destination. These best path computations are then installed in the routing table, sometimes called the configuration table or the forwarding table.

A router may run several different routing protocols, such as EIGRP, IGRP, OSPF and RIP. In computing a route for a particular destination, the protocol result with the best result (e.g., the shortest administrative distance) may be chosen. The other protocol results may serve as backups if the preferred route fails. If the preferred route fails, the next best route according to another protocol may be used.

Several different solutions have been proposed for implementing routing lookups, including direct lookup, route caching, content addressable memories (CAM), and “tries.” Direct lookup provides one table entry for every destination address. This approach is simple, but is very memory intensive and not easily updated. Lookup caching stores the most recently used routes in a cache of on the linecard. This approach uses the existing cache of the linecard processor, but has poor spatial/temporal locality and the worst-case lookup time is long. The CAM approach can be fast, but requires multiple special Application Specific Integrated Circuits (ASICs) that can hoard power and board space.

Typical routing tables consist of a database of “rules,” each rule containing a prefix of a 32 bit IP address (i.e., a network address) and a corresponding next hop IP address. For example, the table may have a 32 bit IP address defining the route address entry and a prefix length in bits (referred to as the number of bits in the “subnet mask”) that defines bit positions where matches are enabled for the lookup operation. Where the prefix mask is 0, no lookup is performed, i.e., the absence of a match between the destination IP address and the route entry at that bit is ignored. The table usually includes an output port corresponding to each entry.

The route selected by the router is based on comparing the destination IP address to the various rules (i.e., the prefix entries) in order to identify the longest matching prefix for the rules. The rule having the longest matching prefix corresponds to the computed best path and is used to identify the next hop IP address. For example, consider a destination address 192.168.32.1 that is compared to a table with route entries 192.168.32.0/26 (i.e., a 26 bit prefix) and 192.168.32.0/24 (i.e., a 24 bit prefix). The destination address matches or falls within both the first entry (192.168.32.0-192.168.32.63) and the second entry (192.163.32.0-192.163.32.255). However, because the first entry represents a longer prefix match (through 26 MSB bits compared to only 24 MSB bits), the route according to the first entry is selected.

The challenge of efficiently identifying the longest prefix match is a well-known problem in the computer industry that greatly impacts router performance. The problem can be described in connection with the exemplary routing table below:

TABLE 1

| Route | Next Hop |
|---|---|
| R1/M1 | H1 |
| R2/M2 | H2 |
| . . . | . . . |
| Rn/Mn | Hn |

For a destination IP address D, D is compared to each routing entry Ri based on its prefix length Mi, e.g., R1/M1, R2/M2 and so on. If there is a match, then the corresponding next hop address is selected as a possible next hop. By making this comparison for each route entry i, a total set of matching route entries can be determined. The entry with the longest prefix (Mi value) is selected as the best route.

Therefore, the concept of the longest prefix match specifies that the lookup operation should resolve multiple matches by selecting the matched entry with the longest prefix match.

A common approach to the longest prefix match problem has been to undertake different “tries” whereby the destination IP address is compared to the rule prefixes on a number of tries. A trie is a well known data structure comprising a binary tree in which it is possible to navigate down the tree using a bit number i of the “search value” (i.e., the destination IP address) to choose between the left and right sub-trees at level i. In other words, the trie is a data structure that can be used for storing strings, whereby each string is represented by a leaf in the tree and the string's value is defined by the path from the root of the tree to the leaf.

In essence, the trie approach employs a tree-based data structure to store the routing table (more specifically, the forwarding table) that is more compact than a full table and that can be searched in a logical fashion. For an IPv4 system, the maximum trie depth is 32, corresponding to the full length of a destination IP address, and corresponding to a maximum number of memory lookups of 32 along one path. Each “node” has two pointers (“descendents”) and each “leaf” (a node corresponding to a prefix entry) stores an output port (i.e., corresponding to a next hop address). An example of a single bit trie data structure is shown below in FIG. 1.

The single bit trie lookup approach can result in difficulties with search time and memory size for large routing tables. When the routing table is implemented in this fashion, there will be one memory lookup and one comparison needed for each branching point in the tree. For example, 15-16 nodes can be required for 40,000 entries and up to 2 MB memory may be required.

FIG. 2 is another representation of how a routing table can be represented as a tree searched according to the single bit trie approach. According to FIG. 2, each successive bit in a prefix defines a lower level in the tree having a left descendent (0) and a right descendent (1). The binary tree representation has more nodes than there are prefixes because every additional bit in the prefix creates an additional node, although the routing table may not have a separate entry (prefix entry) for that node. As shown in FIG. 2, nodes having a prefix entry are labeled with their corresponding next hop value. In FIG. 2, the routing table has four routes (prefix entries) that are reflected in the tree. The root node, defining the null prefix (the mask is 255.255.255.255), defines the route table entry * [symbol] 1. This means that all destination IP addresses will have a prefix match for a next hop destination of 1. The other prefixes defined on the tree are 00* [symbol] 2, 10* [symbol] 2, and 11* [symbol] 3. Thus, FIG. 2 provides a tree representation of four prefix entries (*, 00*, 10*, and 11*), which route to three different next hop destinations (1, 2, and 3).

The basic single bit trie approach can be inefficient because the number of nodes and depth may be large. One approach to addressing these drawbacks is based on “path compression,” whereby each internal node with only one child is removed and a “skip value” is stored to reflect the omitted nodes. This approach results in a “Patricia” tree. Path compression effectively reduces parts of the tree that are lightly populated.

Another approach has been called “multi-bit tries,” which reduces the number of trie levels and, accordingly, the number of memory accesses. Multi-bit tries do this by taking several consecutive search bit values at each level and using them as an index for a direct access to an array of next level addresses of the search structure. In a multibit trie lookup, sometimes called a compressed trie approach or “Level Compression” (LC) approach, more than 1 bit is consumed at each level of the trie. The number of bits to be inspected per step is called the “stride.” FIG. 3 illustrates a multibit trie data structure where two bits are used at each trie level.

In this case, the maximum trie depth is 16, corresponding to a maximum number of memory lookups of 32. The general flow is to check the appropriate child pointer at each node. If the answer is null (no match for any child pointer), the next hop value for this node is returned. If the answer is not null (there is a match), the pointer is followed and the process is repeated.

Unfortunately, the multi-bit tries approach to the longest prefix match problem can lead to a very high memory demand per prefix. This approach can also lead to complex processing at each level of the tree. Loops may be required at each level and backtracking may also be required. Lower level nodes may have to be checked for potential matches before proceeding with a search. These are all significant disadvantages.

One of the many longest prefix match algorithms based on multi-bit tries is described in the article Stefan Nilsson and Gunnar Karlsson, “IP-Address Lookup Using LC-Tries,” IEEE Journal on Selected Areas in Communications, Vol. 17, No. 6, pages 1083-1092 (June 1999). This LC trie scheme is based on implementing multibit tries using what the authors call “level compression.”

The program fragment in the Nilsson-Karlsson algorithm that performs the longest prefix match address lookup is the following:

/* Return a nexthop or 0 if not found */
nexthop_t find(word s, routtable_t t)
{

node_t node;
int pos, branch, adr;
word bitmask;
int preadr;
/* Traverse the trie */
node = t->trie[0];
pos = GETSKIP(node);
branch = GETBRANCH(node);
adr = GETADR(node);
while (branch != 0) {

node = t->trie[adr + EXTRACT(pos, branch, s)];
pos += branch + GETSKIP(node);
branch = GETBRANCH(node);
adr = GETADR(node);

}
/* Was this a hit? */
bitmask = t->base[adr].str \hat{ }s
if (EXTRACT(0, t->base[adr].len, bitmask) == 0)

return t->nexthop [t->base[adr].nexthop];

/* If not, look in the prefix tree */
preadr = t->base[adr].pre;
while (preadr != NOPRE) {

if (EXTRACT(0, t->pre[preadr].len, bitmask) == 0)

return t->nexthop[t->pre[preadr].nexthop];

preadr = t->pre[preadr].pre;

}
/* Debugging printout for failed search */
/*
printf(“base: ”);
for (j = 0; j < 32; j++) {

printf(“%ld”, t->base[adr].str<>31);
if (j%8 == 7) printf(“ ”);

}
printf(“ (%lu) (%i)\n”, t->base[adr].str, t->base[adr].len);
printf(“sear: ”);
for (j = 0; j < 32; j++) {

printf(“%ld”, s<>31)
if (j%8 == 7) printf(“ ”);

}
printf(“\n”);
printf(“adr: %lu\n”, adr);
*/
return 0; /* Not found */

}

It can be seen that the above algorithm, like many other multi-bit tries algorithms, performs a loop on the trie levels, and the depth search is variable. It can also be seen that the processing within each level takes more than a pair of machine instructions.

There are other drawbacks and disadvantages in the prior art.

### SUMMARY OF THE INVENTION

An embodiment of the present invention comprises a data structure and method for performing longest prefix matching processing, such as that employed for IP destination address lookups. The technique, referred as the Optimized Multi-bit Trie (OMT) approach, maps a routing table having prefix entries and next hop identification (NHID) values into a compact and readily searchable data structure.

According to one aspect of the invention, a data structure stored in memory is provided that includes a root node array providing indexes to second level nodes based on a first field; an array of intermediate nodes providing indexes to next-level nodes based on the field for that level; and an array of leaf nodes providing a result value based on the last field.

According to another aspect of the invention, a method for constructing a data structure is provided, including the steps of selecting the number of levels for the OMT data structure; partitioning each prefix entry into fields corresponding to the number of levels; establishing a root node that indexes to second level intermediate nodes based on the first field; establishing a plurality of intermediate nodes for the second through the next-to-last levels, the intermediate nodes providing an index to a next-level node based on the field corresponding to that level; and establishing a plurality of leaf nodes providing a result value based on the field corresponding to the last level.

According to yet another aspect of the invention, a method for processing a data structure in order to identify an LPM match is provided, including the steps of splitting the search value into a number of fields corresponding to the number of levels; accessing a first level node based on a first field and acquiring an index to second level node; accessing intermediate nodes at each subsequent level based on the field for that level and acquiring an index to a node at the next level; and accessing a leaf node at the last level and acquiring a result value based on the last field.

The invention has a number of benefits and advantages. LPM searches of the OMT data structure can be performed without backtracking and without loops on the trie level. LPM searches of the OMT data structure can be performed without performing condition checks. The OMT data structure is constructed for a routing table so that the LPM searches are performed according to a fixed number of levels. The OMT technique reduces the number of memory accesses required for identifying LPM matches and is fast and memory efficient.

Accordingly, it is one object of the present invention to overcome one or more of the aforementioned and other limitations of existing systems and methods for IP destination address lookups used by network routers.

Another object of the invention is to provide a system and method for IP destination address lookups that is fast and memory efficient.

Another object of the invention is to provide a system and method for IP destination address lookups that describes a data structure for representing a routing table that is readily searched in order to identify a longest matching prefix.

Another object of the invention is to provide a system and method for IP destination address lookups which reduces the number of memory accesses required to identify a longest matching prefix.

Another object of the invention is to provide a system and method for IP destination address lookups which avoids backtracking so that nodes in a tree do not have to be visited more than once in identifying a longest matching prefix.

Another object of the invention is to provide a system and method for IP destination address lookups which avoids loops on the trie level.

Another object of the invention is to provide a system and method for IP destination address lookups which eliminates or reduces the need for condition checks.

The accompanying drawings are included to provide a further understanding of the invention and are incorporated in and constitute part of this specification, illustrate several embodiments of the invention and, together with the description, serve to explain the principles of the invention. It will become apparent from the drawings and detailed description that other objects, advantages and benefits of the invention also exist.

Additional features and advantages of the invention will be set forth in the description that follows, and in part will be apparent from the description, or may be learned by practice of the invention. The objectives and other advantages of the invention will be realized and attained by the system and methods, particularly pointed out in the written description and claims hereof as well as the appended drawings.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is a diagram of a data structure for a single bit trie for representing a router table.

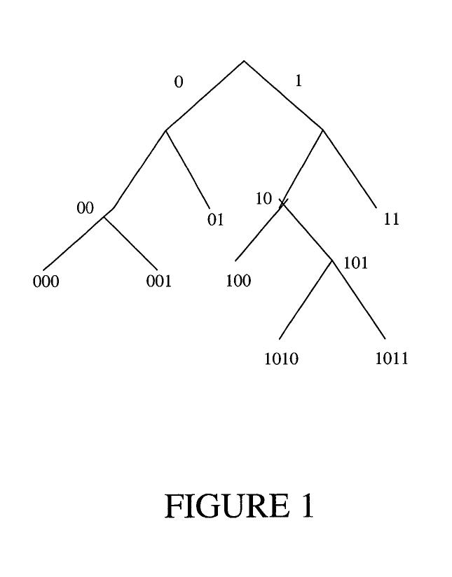

FIG. 2 is a diagram of a router table represented by a single bit trie tree structure.

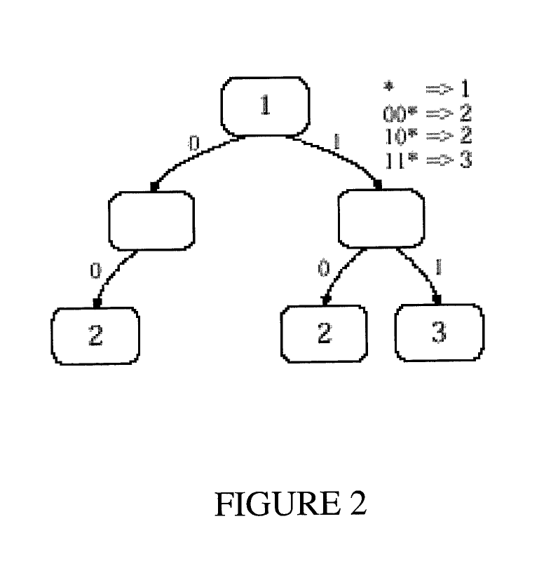

FIG. 3 is a diagram of a data structure for a multi-bit trie tree structure.

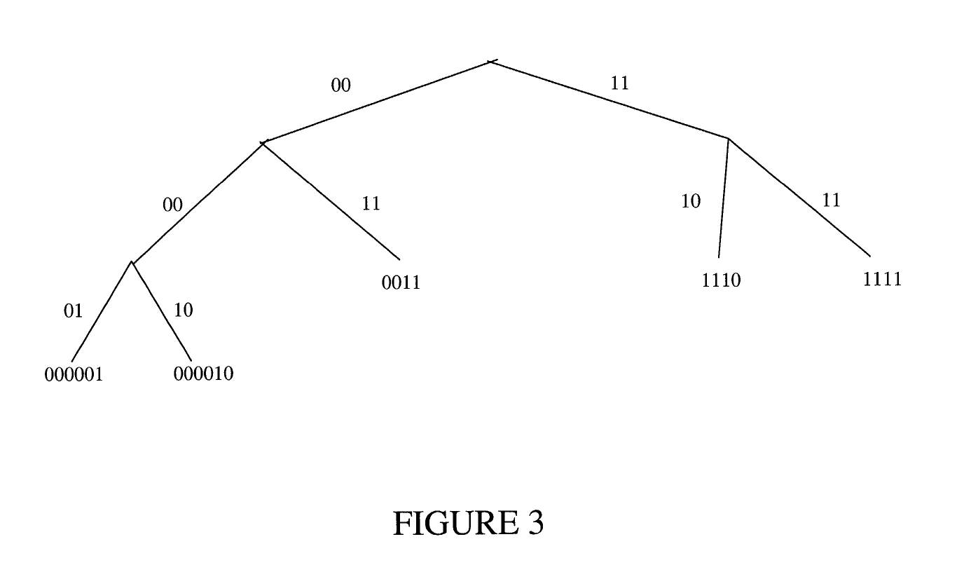

FIG. 4 is a diagram of a logical structure of a data structure built from a first exemplary routing table according to an embodiment of the invention.

FIG. 5 is a diagram of a logical structure of a data structure built from a second exemplary routing table according to an embodiment of the invention.

FIG. 6 is a flow diagram of a method for constructing a data structure for a given routing table in accordance with an embodiment of the invention.

FIG. 7 is a flow diagram of a method in accordance with an embodiment of the invention for searching a data structure representing a routing table in order to identify a longest prefix match.

### DETAILED DESCRIPTION OF THE INVENTION

Generally, the invention relates to a method of converting a routing table into a data structure that is easily and quickly searched. Of course, while it is disclosed in connection with its application to IP routing lookup processing, the invention finds beneficial application to other contexts where longest prefix match (LPM) type processing is performed. By converting a routing table into a data structure as disclosed herein, straightforward logic can be employed to search the data structure in order to identify next hop addresses based on LPM. This logic can be readily implemented into a software algorithm.

The invention herein may be referred to as the “Optimized Multi-bit Tries” (OMT) approach. According to one embodiment of the invention, 8 or 16 bit indexes may be used instead of pointers in order to reduce memory demand. However, according to another approach, the OMT system and method may be implemented using pointers instead.

Preferably, the invention is implemented using a large first level array (e.g., 11 bits wide) in order to increase the lookup speed. However, the relative size of the first level array can be varied without departing from the true spirit and scope of the instant invention.

According to one embodiment of the invention, each node includes backtracking next hop identification (NHID) values that are inserted when the data structure is constructed. This provides the benefit of eliminating the need for backtracking during LPM processing.

When performing LPM searching of the data structure of the present invention, the search proceeds for a fixed number of levels and there are no loops on levels in the forwarding code. The number of levels for the search is established when a given routing table is mapped into a logical data structure in accordance with the invention. For a specific implementation, the number of levels may be established at design time based on an acceptable tradeoff between memory consumption, search time, and maximum number of prefixes. The number of levels could range from 2-32 for IPv4. Of course, if the number of levels is selected to be 32 then the OMT lookup processing according to the invention will provide the benefit of reduced processing at each level, but not the benefit of a reduced number of memory accesses.

Different values for the number of search levels can be selected, such as 4, 8, 16, etc. Generally, there is a tradeoff between memory consumption and the number of memory accesses, such that as the number of search levels increases the memory consumption will decrease. According to one embodiment of the invention discussed herein, the number of levels is selected to be 8, corresponding to 8 memory accesses per lookup, which represents an acceptable balance between the number of memory accesses and memory consumption.

Additionally, when performing LPM searching of the data structure according to the invention, there is no need for condition checks, such a compares, tests, conditional branches, or other changes in program flow. In particular, there is no need to check potentially matching lower level nodes. This is because the data structure is constructed so that at the time of forwarding table construction, the “son” index is set to point to a special type of node if there is no matching lower level node. This attribute of the invention (the use of this special node to indicate when there is no potentially matching lower level node) avoids some of the complex processing required in conventional multi-bit LPM techniques that must check for lower level node matches before proceeding with a search.

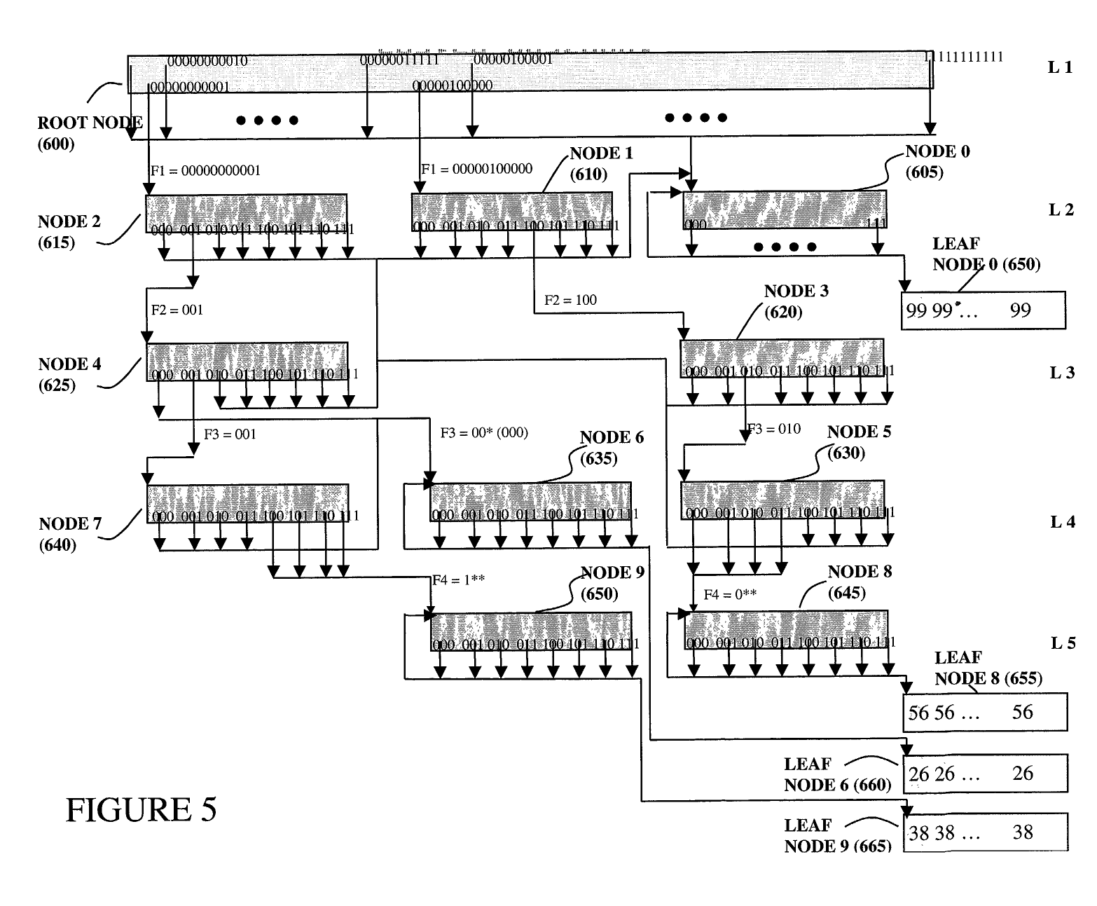

By way of explanation, according to the invention each node can be considered to comprise an array of indexes to the next level of nodes that are sons. Depending on how a given routing table is mapped into a data structure according to the invention, some of the sons may lead to matching rules for possible search address values, whereas some of the sons may not lead to matching rules (the latter can be referred to as “non-leading sons”). There is a default rule so that, absent a match to an actual prefix entry, a default destination (e.g., the default rule might return a “drop this packet” action or “forward to default interface” [default NHID]) action) will still be returned for a search value. The default rule may be expressed as the * prefix, meaning that all search values will, at a minimum, match the default rule. According to one aspect of the invention, therefore, the indexes of those sons that do not lead to matching rules (non-leading sons) will point to this special node that corresponds to the default rule. (An example of this special node is node 0 of FIG. 5, discussed below.) The indexes of the other sons that do lead to matching rules will point to next-level intermediate nodes.

Additionally, memory optimization can be provided by a further enhancement to the invention. In particular, when all sons of a given parent node will result in the same prefix rule match (i.e., the same NHID will be returned for all sons), and if there are still additional search levels remaining, it is not necessary to allocate an additional node for each of the additional search levels. Rather, a similar technique as employed for the special node discussed above can be employed so that these nodes (the parent node) will point or index to themselves. (An example is node 4 and node 5 of FIG. 5 below, both of which index themselves for the scenario provided. Node 4 indexes itself for the levels 4-7 searches. Node 5 indexes itself for the levels 5-7 searches.)

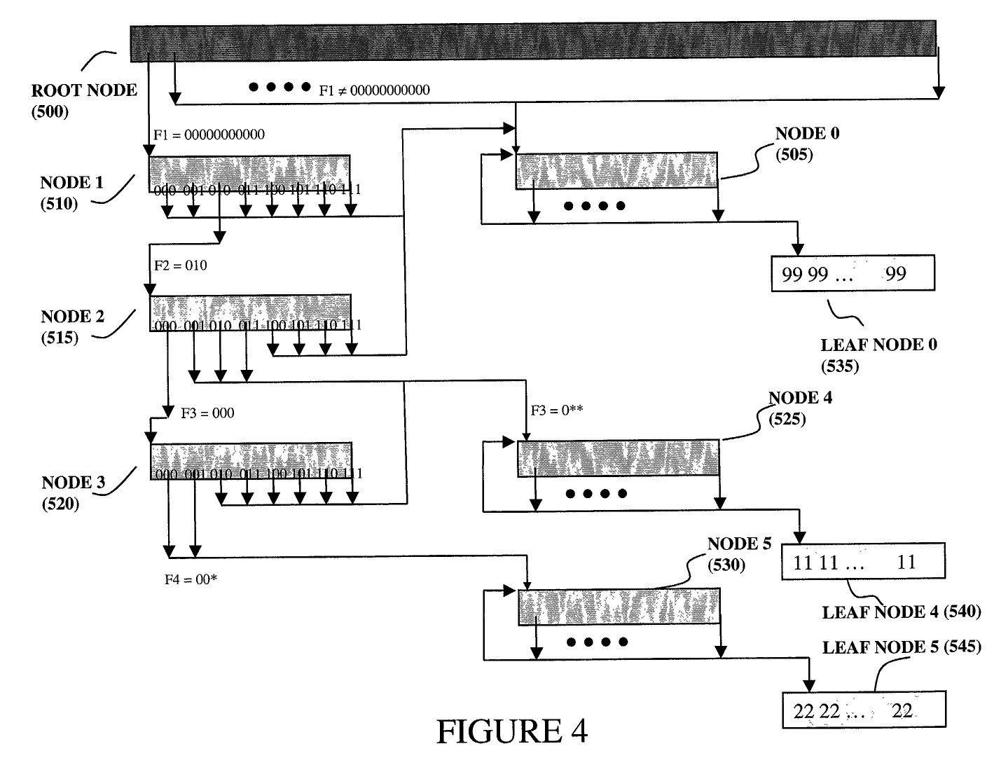

According to the invention, after proceeding through the fixed number of search steps and reaching the nodes at the level just before the last level (e.g., in the example of FIG. 4, level 7), the correct NHID (i.e., the one corresponding to the longest prefix match) is determined. Determining the correct NHID could be accomplished in various fashions that are within the skill of the ordinary artisan. According to one exemplary approach, the “leaf” nodes of the tree reside in a separate array, and the “result index” from the previous level node is used to locate the leaf node. In particular, the last bits of the search value (i.e., the destination IP address) are used to locate the NHID within the leaf node. This approach provides that for any “intermediate” nodes that point to themselves, the leaf node is located in the same location index in the leaf node array as the leaf node's “father” index in the intermediate node array. For the other kinds of nodes, the leaf node may be placed anywhere in the leaf node array. (Referring to the example provided in connection with FIG. 4, discussed further below, because there is no matching leaf node associated with nodes 1-3, those nodes can be located anywhere in the first array.)

Therefore, the processing of the OMT data structure can be described as follows. Based on the number of steps, the search value is broken up into a series of fields. At each level, the bits from the field for that level are used to access the node and retrieve the index/pointer for the next level. Then at the next level, the next field is used to access the node at that level using the index/pointer acquired from the previous level, and so forth. Eventually, when the next to last level is reached (e.g., at step 7 in an 8-level OMT data structure), the index acquired from the node in level 7 is used with the last field (field 8 of the search value) in order to acquire the NHID entry for the leaf corresponding to the last field.

Generally, the data structure constructed in accordance with the invention has intermediate nodes (e.g., levels 1 . . . n−1 for an n-level OMT structure) that contain indexes of nodes in the next levels, while the leaf nodes (i.e., level n) do not contain an index to a further level. Rather, the leaf nodes contain the resulting NHID values. One issue, therefore, exists for nodes that perform both roles (such as the nodes which point to themselves, as discussed above). If such nodes perform both roles, then the value at the node corresponds to both the index for the intermediate search and the result (NHID) value.

According to one embodiment of the invention, this issue may be addressed by constructing the data structure to have two arrays of nodes, a first array of intermediate nodes (each node having a next-level index) and a second array of leaf nodes (each node having an NHID result). Accordingly, at all levels of the search except for the last level (i.e., 1 . . . n−1) the index will be used to access the first array, while at the last level (i.e., n) the index will be used to access the second array. This embodiment is compatible with indexes. This embodiment is illustrated in FIGS. 4-5, discussed below.

According to another embodiment of the invention, the issue may be addressed by implementing more complex nodes having two parts. This latter embodiment would be compatible with either indexes or pointers. For example, pointers and 3 bit search value fragments could be used such that each node would have 8 values. Each node contains an array of 8 pointers of 4 bytes each (the first part of the node having the next-level indexes) and, followed by an offset of 32, then an array of 8 results of 2 bytes each (the second part of the node having the NHID values). The search logic for this embodiment provides that in the intermediate stages of the search (1 . . . n−1) the first part of the node is accessed (e.g., node [search_value_fragment] in C code), while in the last stage of the search (n) the second part of the node is accessed (e.g., (node+8[last_search_value_fragment] in C code). In this embodiment, nodes that do not point to leaf nodes (e.g., nodes 1, 2 and 3 of FIG. 4) do not have to be allocated the increased memory size associated with this approach.

According to a preferred embodiment of the invention which improves performance, the data structure constructed in accordance with the invention actually has three arrays of nodes: a root node array (at level 1 for indexing to level 2 intermediate nodes), an intermediate node array (at levels 2 . . . n−1 for indexing to next-level intermediate nodes), and a leaf node array (at level n for providing the NHID results).

Construction of OMT Data Structures for Routing Tables

Table 1 below provides an exemplary routing table having two rules (two prefixes and a null or default rule) that is mapped into a searchable data structure in accordance with the procedures discussed above.

TABLE 1
Exemplary 2-Rule Routing Table

| | NHID (Next | Prefix divided into: | | | | | | | |
|---|---|---|---|---|---|---|---|---|---|
| Prefix | Hop ID) | F1 | F2 | F3 | F4 | F5 | F6 | F7 | F8 |
| 000000000000100* | 11 | 0000000000 | 010 | 0?? | ??? | ??? | ??? | ??? | ??? |
| 0000000000001000000* | 22 | 0000000000 | 010 | 000 | 00? | ??? | ??? | ??? | ??? |
| * (default or null) | 99 | | | | | | | | |

As can be seen from the third column of Table 1, each prefix is divided into eight fields: 11 bits [field 1], 3 bits [field 2], 3 bits [field 3], 3 bits [field 4], 3 bits [field 5], 3bits [field 6], 3 bits [field 7], and 3 bits [field 8]. These eight fields are then used to construct the data structure in accordance with the present invention. FIG. 4 illustrates the logical data structure according to one embodiment of the invention that is built from the exemplary routing table of Table 1. The logical data structure of FIG. 4 includes root node (500), node 0 (505), node 1 (510), node 2 (515), node 3 (520), node 4 (525), and node 5 (530). The root node (500) and nodes 0-5 (505-530) constitute the first array discussed previously. The logical data structure of FIG. 4 also includes leaf node 0 (535), leaf node 4 (540), and leaf node 5 (545). These leaf nodes constitute the second array previously discussed.

The physical data structure built from the above two rules can be summarized as follows:

Root (level 1) node:

root_node[0]: 1

root_node[i] (i=0 . . . 2047, i!=0): 0

node 0: a level 2,3,4,5,6,7 node matching only the default rule:

intermediate_nodes[0][j] (j=0 . . . 7): 0

node 1: a level 2 node matching both rules:

intermediate_nodes[1][2]: 2

intermediate_nodes[1][j] (j=0 . . . 7, j!=2): 0

node 2: a level 3 node matching both rules:

intermediate_nodes[2][0]: 3

intermediate_nodes[2][j] (j=1 . . . 3): 4

intermediate_nodes[2][j] (j=4 . . . 7): 0

node 3: a level 4 node matching the second rule:

intermediate_nodes[3][j] (j=0 . . . 1): 5

intermediate_nodes[3][j] (j=2 . . . 7): 4

node 4: a level 4,5,6,7 node matching the first rule:

intermediate_nodes[4][j] (j=0 . . . 7): 4

node 5: a level 5,6,7 node matching the second rule:

intermediate_nodes[5][j] (j=0 . . . 7): 5

Leaf node 0, matching only the default rule:

leaf_nodes[0][j] (j=0 . . . 7): 99 (the default next hop ID)

Leaf node 4, matching the first rule:

leaf_nodes[4][j] (j=0 . . . 7): 11

Leaf node 5, matching only the second rule:

leaf_nodes[5][j] (j=0 . . . 7): 22

Table 2 below provides a second exemplary routing table having three rules (three prefixes and a null or default rule) that is mapped into a searchable data structure in accordance with the procedures discussed above.

TABLE 2
Exemplary 3-Rule Routing Table

| | NHID (Next | Prefix divided into: | | | | | | | |
|---|---|---|---|---|---|---|---|---|---|
| Prefix | Hop ID) | F1 | F2 | F3 | F4 | F5 | F6 | F7 | F8 |
| 0000000000100100* | 26 | 00000000001 | 001 | 00? | ??? | ??? | ??? | ??? | ??? |
| 000000000010010011* | 38 | 00000000001 | 001 | 001 | 1?? | ??? | ??? | ??? | ??? |
| 000001000001000100* | 56 | 00000100000 | 100 | 010 | 0?? | ??? | ??? | ??? | ??? |
| * (default or null) | 99 | | | | | | | | |

As can be seen from the third column of Table 2, each prefix is divided into eight fields: 11 bits [field 1], 3 bits [field 2], 3 bits [field 3], 3 bits [field 4 ], 3 bits [field 5], 3 bits [field 6], 3 bits [field 7], and 3 bits [field 8]. These eight fields are then used to construct the data structure in accordance with the present invention. FIG. 5 illustrates the logical data structure according to one embodiment of the invention that is built from the exemplary routing table of Table 2.

The logical data structure of FIG. 5 includes root node (600), node 0 (605), node 1 (610), node 2 (615), node 3 (620), node 4 (625), node 5 (630), node 6 (635), node 7 (640), node 8 (645), and node 9 (650). The root node (600) and nodes 0-9 (605-650) constitute the first array discussed previously. The logical data structure of FIG. 5 also includes leaf node 0 (650), leaf node 6 (660), leaf node 8 (655), and leaf node 9 (665). These leaf nodes constitute the second array previously discussed.

The physical data structure built from the above three rules can be summarized as follows:

Root (level 1) node:

root_node[1]: 2

root_node[32]: 1

root_node[i] (i=0, 2 . . . 32, 33 . . . 2047): 0

node 0: a level 2,3,4,5,6,7 node matching only the default rule:

intermediate_nodes[0][j] (j=0 . . . 7): 0

node 1: a level 2 node matching the third rule:

intermediate_nodes[1][4]: 3

intermediate_nodes[1][j] (j=0 . . . 3, 5 . . . 7): 0

node 2: a level 2 node matching the first and second rules:

intermediate_nodes[2][1]: 4

intermediate_nodes[2][j] (j=0, 2 . . . 7): 0

node 3: a level 3 node matching the third rule:

intermediate_nodes[3][2]: 5

intermediate_nodes[3][j] (j=0 . . . 1, 3 . . . 7): 0

node 4: a level 3 node matching the first and second rules:

intermediate_nodes[4][1]: 7

intermediate_nodes[4][0]: 6

intermediate_nodes[4][j] (j=2 . . . 7): 0

node 5: a level 4 node matching the third rule:

intermediate_nodes[5][j] (j=0 . . . 3): 8

intermediate_nodes[5][j] (j=4 . . . 7): 0

node 6: a level 4-7 node matching the first rule:

intermediate_nodes[6][j] (=0 . . . 7): 6

node 7: a level 4 node matching the second rule:

intermediate_nodes[7][j] (j=4 . . . 7): 9

intermediate_nodes[7][j] (j=0 . . . 3): 6

node 8: a level 5-7 l node matching the third rule:

intermediate_nodes[8][j] (j=0 . . . 7): 8

node 9: a level 5-7 node matching the second rule:

intermediate_nodes[9][j] (j=0 . . . 7): 9

Leaf node 0, matching only the default rule:

leaf_nodes[0][j] (j=0 . . . 7): 99 (the default next hop ID)

Leaf node 6, matching the first rule:

leaf_nodes[6][j] (j=0 . . . 7): 26

Leaf node 8, matching the third rule:

leaf_nodes[8][j] (j=0 . . . 7): 56

Leaf node 9, matching the second rule:

leaf_nodes[9][j] (j=0 . . . 7): 38

The data structures that are defined by the above physical descriptions and illustrated by the logical diagrams of FIGS. 4 and 5 can be readily extended to other routing tables simply by following the same procedures. By following those procedures, OMT data structures can be constructed in accordance with the invention for various routing tables having varying numbers of rules. Once constructed, such OMT data structures enable processing of the OMT data structures to perform LPM matching with a limited number of memory accesses (fixed depth search), no backtracking, no loops per level, no condition checks, and fast and straightforward processing.

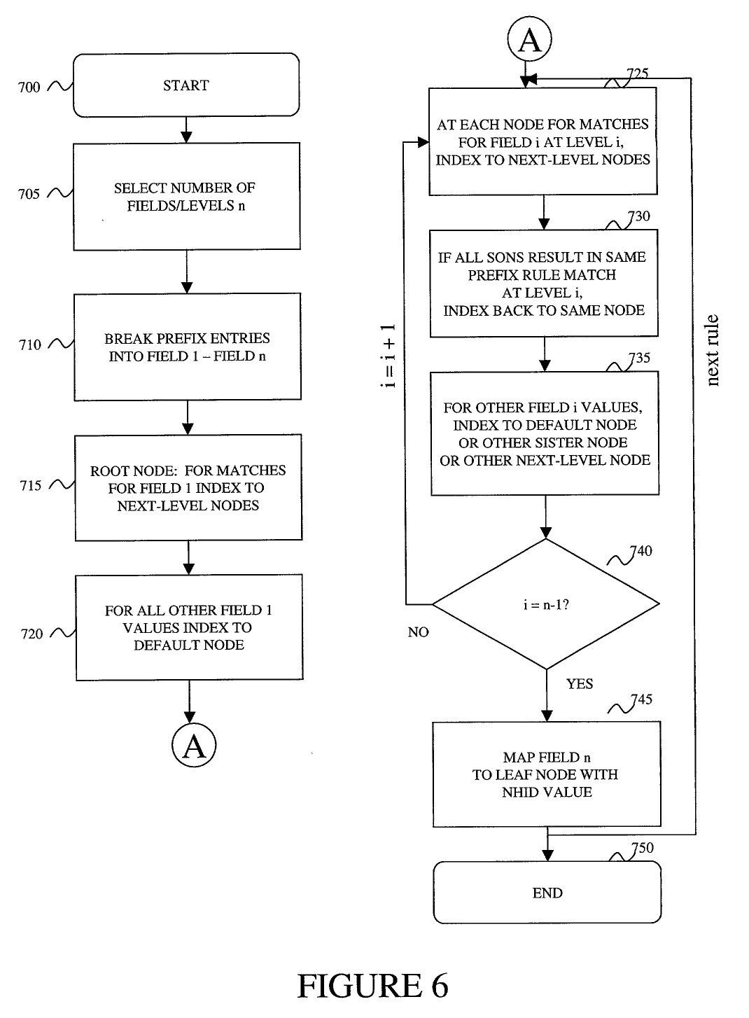

FIG. 6 is a flow diagram of a method for constructing a data structure for a given routing table in accordance with an embodiment of the invention. After starting at 700, the method proceeds to 705 where the number of fields/levels for the data structure is selected. At 710, the prefix entries for the various rules in the routing table are broken into a series of fields, Field 1 to Field n. As previously stated, the number of fields can vary and the size of each field also may vary. According to one embodiment, n=8, and the size of Field 1 is 11 bits and the size of each of Fields 2-8 is 3 bits. At step 715, the root node is established whereby matches to the Field 1 value are indexed to next-level (level 2) nodes. For other (non-matching) Field 1 values, the index is to the default (level 2) node.

In steps 725-745, the nodes and indexes for levels 2-n are established for each of the rules. To ensure that preference is given to longer prefixes, the pointers/indexes should point to the solution for the longest of the matching prefixes when the path through the data structure to several prefixes proceeds through the same node. In constructing the data structure in accordance with FIG. 6, therefore, this can be accomplished by sorting the prefixes according to ascending length before performing the loop on prefixes at steps 725-745. Accordingly, FIG. 6 may include the optional step 722 (not shown) of sorting the prefixes according to ascending length and mapping the prefixes into the data structure in that order.

The value of i begins at 2. At 725, at each node for matches for field i at level i, indexes are established to next-level nodes. However, step 730 provides that if all sons result in the same prefix rule match at level i, the index is back to the same node.

For other field i values, at step 735 the index is to (1) the default node [e.g., see node 2 of FIG. 4, whereby intermediate_nodes[2][j] (j=4 . . . 7): 0] or (2) to a sister node [e.g., see node 3 of FIG. 4, whereby intermediate_nodes[3][j] (j=2 . . . 7): 4] or (3) to an other next-level node [e.g., see node 2 of FIG. 4, whereby intermediate_nodes[2][j] (j=1 . . . 3): 4]. Option (1) above corresponds to the default rule. Options (2) and (3) correspond to nodes for a prefix (rule) other than the one currently being mapped. Because step 735 may entail examination of rules other than the rule currently being examined, those of skill in the art will recognize that step 735 for indexing non-matching values of field i may be skipped and deferred until later or at the end of the overall process.

At step 740, if i is <n−1, the method returns to step 725 so that additional nodes and indexes can be established for the remaining fields for that rule.

At step 740, if i=n−1, the method proceeds to step 745. At 745, field n is mapped to a leaf node established with the NHID value. If there are additional rules to be mapped into the data structure, the method returns to 725 for the next rule. If all rules have been mapped, the method is complete at 750.

Design and coding of an algorithm for implementing construction or updating of data structures in accordance with the invention is well within the level of skill in the art.

Searching the OMT Data Structure and Simulated Performance

An exemplary implementation of the invention was simulated in order to assess performance. According to this exemplary implementation, the search is performed using 8 memory accesses (i.e., the number of levels n=8). The 32 bit search value (destination IP address) is divided into 8 fields as follows: 11 bits [field 1], 3 bits [field 2], 3 bits [field 3], 3 bits [field 4], 3 bits [field 5], 3 bits [field 6], 3 bits [field 7], and 3 bits [field 8]. According to the data structure that was constructed, the intermediate nodes are maintained in an array of up to 64 k nodes, whereby each node includes eight (8) 16 bit indexes of next-level nodes.

While the exemplary implementation uses n=8 stages with the search value subdivided into a search field 1 of 11 bits and search fields 2-8 of 3 bits, variations from this exemplary implementation could easily be incorporated without departing from the true spirit and scope of the present invention. For example, the exemplary implementation uses a search field of size 3 bits for fields 2-8. This has the benefit of making all nodes in levels 2-8 the same size and allows an efficient allocation of nodes from the same array.

According to another embodiment, the sizes of the search fields could easily be selected to be nonuniform. Implementing nonuniform field sizes for levels 2-8 is more readily accommodated with pointers than indexes. Implementing nonuniform field sizes also may complicate the data structure update process. For example, the previously discussed special nodes would have to be sized to be the maximum of the sizes of the levels they cover.

The LPM processing of the data structure constructed in accordance with the invention can be broken down into eight stages (stages 1-8). In stage 1, the first field (11 MSB bits) of the search value is used to access one of the first 2 k nodes in the array. Then in stages 2-7, the appropriate field is used to access the current node using the index from the prior node and acquire one of eight (8) 16 bit indexes of the next-level node. According to one embodiment, a separate array of nodes could be stored for each level in order to support a larger maximum number of prefixes in the forwarding table. The last stage (stage 8) uses a separate leaf node array wherein the leaf node is selected with the index from the previous stage (stage 7). The last field (field 8) is used to select the 16 bit NHID within the leaf node.

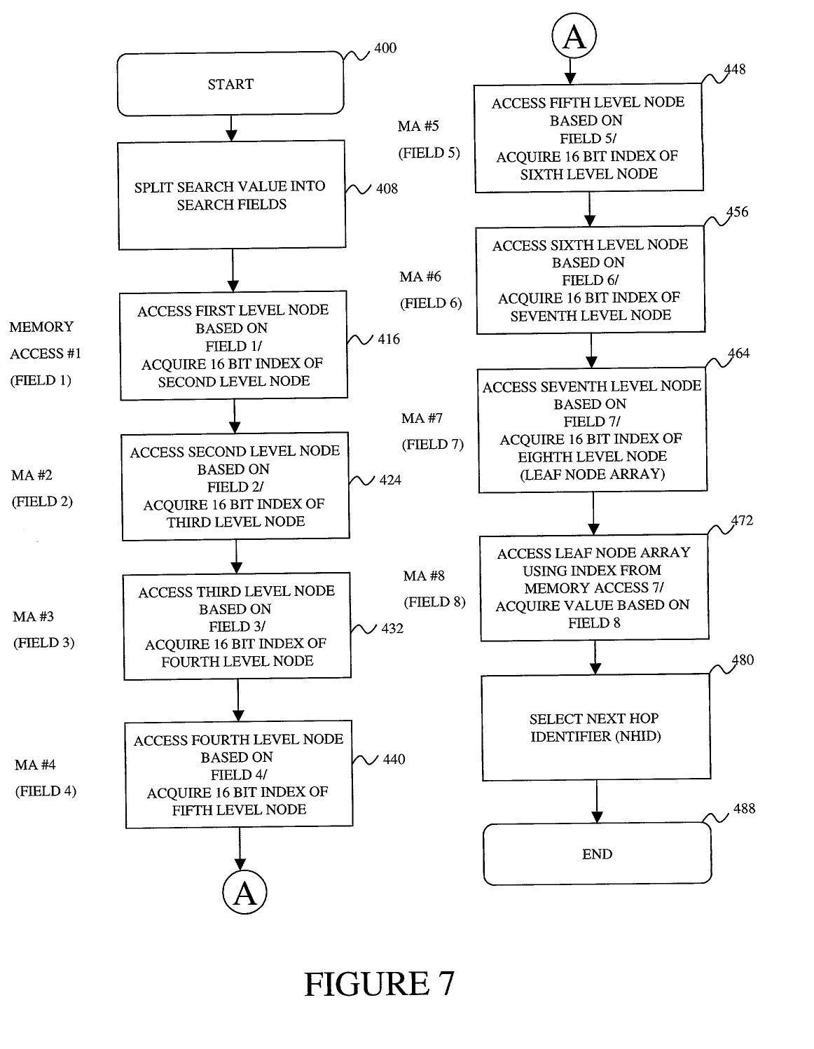

FIG. 7 is a flow diagram of a method according to an embodiment of the invention for searching a data structure constructed in accordance with the invention. After starting at step 400, the method proceeds to step 408, which provides that the search value is split or broken down into a number n of search fields. In the exemplary scenario discussed above, the number of levels n=8, so the search field is broken down into fields 1-8. The size of each field can vary so long as the fields aggregate into the full length of the search value (i.e.., 32 bits for IPv4, 128 bits for IPv6, etc.). In the exemplary scenario given above, step 408 provides for subdividing the search value into field 1 of 11 bits and fields 2-8 of 3 bits each. As previously discussed, the number of search fields can be increased or decreased (e.g., to 4, 5, 16, and so forth), but this entails tradeoffs in the number of memory accesses and complexity of the processing at each level. For example, an alternative 5 level system could be base on fields of 12, 5, 5, 5, and 5 bits.

The method according to FIG. 7 proceeds with step 416, which provides for accessing one of the first level nodes based on field 1 and acquiring an index for the second level nodes. In step 424, a second level node is accessed based on field 2 and the index of the third level nodes is acquired. In step 432, a third level node is accessed based on field 3 and the index of fourth level nodes is acquired. In step 440, a fourth level node is accessed based on field 4 and the index of fifth level nodes is acquired. In step 448, a fifth level node is accessed based on field 5 and the index of sixth level nodes is acquired. In step 456, a sixth level node is accessed based on field 6 and the index of seventh level nodes is acquired. In step 464, a seventh level node is accessed based on field 7 and the index of eighth level nodes (the leaf node array) is acquired. In step 472, the leaf node array is accessed using field 8 in order to select the correct NHID value, as in step 480. The method ends at 488.

FIG. 7 is to be considered exemplary only and can be generalized to correspond to differing number of levels n other than 8. Furthermore, pointers could be used in place of indexes.

According to the invention, the worse case memory demand is seven (7) nodes per prefix. This would occur in the case of a prefix of twenty-nine (29) or greater bits that does not share the intermediate nodes on its pass with the other prefixes. In the more demanding case, such as where about 40 k prefixes are needed for the forwarding table, the first/second/third level nodes serve multiple prefixes and the worse case memory demand is about 4.5 nodes per prefix, corresponding to 72 bytes per prefix.

The worse case memory demand can be reduced in exchange for some performance penalty if a condition test is inserted at some level, such as at level 2. According to this approach, if the number of prefixes matching the search value is less than a threshold, e.g., such as 4, the index will be interpreted as an index to an array of prefix lists instead of intermediate nodes.

According to another variation, in order to reduce the memory demand for leaves, the leaves can be allocated from the lowest unoccupied location in the leaf node array. This may require relocation of the intermediate node that points to the leaf.

Of course, in real networks the network prefixes and host addresses tend to be clustered together. As a result, the real-world average memory demand per LPM search will tend to be significantly less than the worse case demand discussed above.

The above-described simulation was evaluated on a 700 MHz Pentium PC with the OMT lookup processing algorithm implemented using C code. The forwarding table was constructed according to the data structure of the invention for 16 k rules (prefixes) of 32 bit lengths. The simulation involved performing lookups based on randomly-generated search values. The measured performance was approximately 16 million lookups per second, which is excellent performance.

For the above performance simulation, the forwarding portion of the code is provided in Table 3 below according to an embodiment of the invention using indexes:

TABLE 3

| Exemplary Forwarding Code | | Comments |
|---|---|---|
| // The forwarding part of the code of the performance simulation: | | |
| unsigned short root_node[1<<11]; | | -This is the array of the first level having |
| | | 2048 16 bit indexes. |
| unsigned short intermediate_nodes[1<<16][8]; | | -This is the array of all the level 2-level 7 |
| | | nodes, up to 64K nodes total, each node |
| | | containing 8 16 bit indexes. |
| unsigned short leaf_nodes[1<<16][8]; | | -This is the array of leaves having 64K |
| | | leaves, each leave containing 8 16 bit NHID |
| | | values. |
| unsigned short OMT_address_look_up( register unsigned long value) | | |
| { | | |
| | register int f1,f2,f3,f4,f5,f6,f7,f8, index; | |
| | f1 = value>>21; | -This field is the first 11 bits of the search |
| | | value for Field 1. |
| | f2 = (value>>18)&0x7; | -This field is the next 3 bits of the search |
| | | value for Field 2. |
| | f3 = (value>>15)&0x7; | -This field is the next 3 bits of the search |
| | | value for Field 3. |
| | f4 = (value>>12)&0x7; | -Same as above for Field 4. |
| | f5 = (value>>9)&0x7; | -Same as above for Field 5. |
| | f6 = (value>>6)&0x7; | -Same as above for Field 6. |
| | f7 = (value>>3)&0x7; | -Same as above for Field 7. |
| | f8 = value&0x7; | -This field is last three bits of the search |
| | | value for Field 8. |
| | index = root_node[f1]; | -Access the first level node using Field 1 |
| | | as an index and getting the result which is |
| | | the index of the second node. |
| | index = intermediate_nodes[index][f2]; | -Access the second level node using Field 2 |
| | | as an index. |
| | index = intermediate_nodes[index[]f3]; | -Same as above for Field 3. |
| | index = intermediate_nodes[index][f4]; | -Same as above for Field 4. |
| | index = intermediate_nodes[index][f5]; | -Same as above for Field 5. |
| | index = intermediate_nodes[index][f6]; | -Same as above for Field 6. |
| | index = intermediate_nodes[index][f7]; | -Same as above for Field 7. |
| | return leaf_nodes[index][f8]; | -Return NHID value based on Field 8. |

}

According to another embodiment, the forwarding portion of the code according to an embodiment of the invention using pointers rather than indexes is provided in Table 4.

TABLE 4
Exemplary Forwarding Code Using Pointers

pointer = root_node[f1] ;
pointer = (long *)(pointer[f2]) ;

pointer = (long *)(pointer[f3]);
pointer = (long *)(pointer[f4]);
pointer = (long *)(pointer[f5]);
pointer = (long *)(pointer[f6]);
pointer = (long *)(pointer[f7]);
return (pointer + NODE_SIZE)[f8] ;

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

Just by way of example, the OMT data structure and method for processing it to identify LPM type matches is discussed primarily in connection with its application for network routing. However, it should be understood that the OMT data structure and methods for processing same can easily be implemented for other applications (network related or non-network related) requiring LPM type processing. Additionally, for simplicity most of the discussion above is in terms of IPv4 32 bit addresses. It should be understood that the invention can easily be implemented for different length addresses, such as IPv6 128 bit addresses or other variations of address lengths.

What is claimed is:

1. A data structure stored in a memory that is adaptable for LPM processing, comprising:
a root node array providing indexes to second level nodes based on a first field;
an array of intermediate nodes providing indexes to next-level nodes based on the index provided by the previous level and the ith field, wherein the ith field corresponds to the ith level, wherein i is between 2 and n−1, wherein n is the number of levels in the data structure; and
an array of leaf nodes providing a result value based on the nth field.

2. The data structure of claim 1, wherein the data structure can be processed using to identify a longest prefix match for a search value using a fixed number of memory accesses.

3. The data structure of claim 2, wherein the fixed number of memory accesses is 8.

4. The data structure of claim 1, wherein n=8, the first field is 11 bits wide, and each of the remaining fields is 3 bits wide.

5. The data structure of claim 1, wherein the data structure can be processed without backtracking.

6. The data structure of claim 1, wherein the data structure can be processed without performing loops on any level.

7. The data structure of claim 1, wherein the data structure can be processed without performing condition checks.

8. The data structure of claim 1, further comprising a routing table comprising a plurality of prefixes that are mapped into the data structure.

9. The data structure of claim 8, wherein the plurality of prefixes comprise IPv4 prefixes.

10. The data structure of claim 1, wherein the array of intermediate nodes for a present node indexes to a default rule node if there is no matching lower level node, thereby eliminating the need to process beyond the present node to lower level nodes during a search of the data structure.

11. The data structure of claim 1, wherein the array of intermediate nodes for a present node indexes back to the present node when all descendents of the present node result in the same prefix match.

12. A method of constructing a data structure for use in LPM processing, comprising:
selecting a number of levels n for the data structure;
partitioning each of a plurality of prefix entries into n fields;
establishing a root node, wherein the route node indexes to second level nodes for matching first field values, and wherein the route node indexes to a default node for non-matching first field values;
establishing a plurality of intermediate nodes beginning with the second level, wherein each intermediate node:
indexes to a next-level node for matching field values for that level;
indexes back to the same node if all descendents of a node result in the same prefix rule match;
indexes to a sister node; or
indexes back to the default node if there is no matching field value for that level; and
establishing a plurality of leaf nodes providing a result value based on the nth field.

13. The method of claim 12, wherein n=8 and a first field is 11 bits and each of a second, third, fourth, fifth, sixth, seventh, and eighth fields is 1 bits.

14. The method of claim 12, wherein n=5 and a first field is 12 bits and each of a second, third, fourth, and fifth fields is 5 bits.

15. A method of processing a data structure in order to identify an LPM match for a search value, comprising:
splitting the search value into n fields corresponding to a search n levels deep;
accessing a first level node based on a first field and acquiring an index to a second level node;
accessing an intermediate node at level i based on the ith field and acquiring an index of a next-level (i+1)th node, wherein i begins with 2 and ends with n−1; and
accessing a leaf node at level n and acquiring a result value based on the nth field.

16. The method of claim 15, wherein the first level node is a root node.

17. The method of claim 15, wherein the result value is a next hop identification (NHID).

18. The method of claim 15, wherein n=8 and the first field is 11 bits and each of the second through eighth fields is 3 bits.

19. The method of claim 15, wherein n=5 and the first field is 12 bits and each of the second through fifth fields is 5 bits.

20. The method of claim 15, wherein the number of memory accesses equals n for all search values.

21. The method of claim 15, wherein an LPM match is identified without backtracking.

22. The method of claim 15, wherein an LPM match is identified without performing loops on a level.

23. The method of claim 15, wherein an LPM match is identified without performing condition checks.
